(19) United States
(12) Patent Application Publication
(10) Pub. No.: US 2012/0210224 A1
(43) Pub. Date: Aug. 16, 2012

(54) SYSTEM AND METHOD TO ADD AN ASSET AS A FAVORITE FOR CONVENIENT ACCESS OR SHARING ON A SECOND DISPLAY

(75) Inventors: Ling Jun Wong, Champaign, IL (US); Charles McCoy, Coronado, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/234,936

(22) Filed: Sep. 16, 2011

Related U.S. Application Data
(60) Provisional application No. 61/442,039, filed on Feb. 11, 2011.
(60) Provisional application No. 61/442,022, filed on Feb. 11, 2011.

(51) Int. Cl. G06F 3/048

(52) U.S. Cl. 715/716

(57) ABSTRACT

Systems and methods for creating and employing software to handle the playback of media, especially video, in browsers that, in addition to or instead of playing the media in the browser, may use second display protocols to instruct a separate display device to play the media. In one implementation, the software may be in the form of a web or other application. The application or server infrastructure maintains a list of favorite content items and is configured to filter the list to include only those content items, or services with such content items, available for play back on a selected content playback device. In this way, favorite content items and services are made accessible using any second display registered with the user account. Such lists of favorites may be shared with other second displays.

### STATEMENT OF RELATED APPLICATIONS

This application claims the benefit of U.S. Provisional Patent Applications Ser. No. 61/442,039, filed Feb. 11, 2011, entitled “Method to Automatically Synchronize Favorites and/or Recently-Viewed Lists Between Registered Devices”, and Ser. No. 61/442,022, filed Feb. 11, 2011, entitled “Method to Add an Asset as a Favorite for Easy Future Access or Sharing on a Second Display”, both of which are owned by the assignee of the present invention and incorporated by reference herein in their entirety.

### BACKGROUND

Internet delivery of digital content to IPTVs continues to increase, as does the popularity of IPTVs themselves. One feature users may typically access is a list of favorites. While such a list has benefits, in IPTV implementations current lists are generally limited to a single entity, e.g., a single service or device.

### SUMMARY

Systems and methods are disclosed for providing a favorites list of assets or content items (the terms are used interchangeably) that can be shared with another user or across different devices so that there is a common favorites list for the user. The systems and methods describe ways to allow users to add assets to their favorites list for convenient access or future sharing.

In the disclosed systems and methods, software is employed to allow favorites lists to be created with content lists that span multiple services and devices. The systems and methods further control a content playback device, and use principles and protocols of a “second display” to instruct a content playback device to play the content items, e.g., on a device that is optimized for media playback, such as an IPTV or other large television screen and/or a home theater audio system or the like. The software may provide the user with a favorites list of services or assets or both, and may pertain to items selected or viewed on a second display or on a content playback device.

Systems and methods are also described that provide a way for favorites lists to be replicated across devices registered under a single user or group of users to allow the favorites to be accessed on multiple IPTV devices, allowing for an enhanced user experience. The favorites list may also be associated with a profile.

When sharing the favorites list, another user can subscribe to a user's profile, and if appropriate permission is given, the subscribing user may see the other user's favorites list, and have access to all the assets in the favorites list, restricted by the user's IPTV device configurations). Thus, the subscribing user may see a list of favorites that may be partially filtered because there IPTV does not allow them to playback the asset. The same is true if the first user were to choose a different IPTV device. In such systems, in one nonlimiting implementation, any updates to a user's favorites list may not be seen by the subscribing user unless and until approved by the favorites list owner. In creating the favorites list, the asset may be added as a favorite either before playback, during playback, or even after playback, or even in the absence of playback.

In one exemplary implementation, the following steps are performed: on the second display, the user selects an asset as a favorite on the second display. The second display sends asset information to the server, which may in turn store the information and associate it with the user and the device. On subsequent logins, the second display retrieves this information from the server. When the user selects an asset from the list, the second display sends a command to the server, which then retrieves the information and returns the result to the second display. The second display then sends a requisite command to the IPTV for playback as the user account is associated with the favorites list, the favorites lists of services and assets may be synchronized across devices registered under the user.

In some implementations the software on the second display, or second display application, can be in the form of web application that works in association with a web browser, and which may even allow certain items to be played back on the second display. The use of the same allows significant benefits over prior systems. For example, the system and method may be employed with any device with a browser, and is not tied to any particular proprietary technology.

To accomplish the above, software is employed that is installed, in one implementation, on a second display to control and handle media playback. This software may have the ability to play the media in the browser, like traditional media handling software, in addition to the ability to control consumer electronics devices to enable the same to play the media. The software may specify the network location of selected media to content playback devices. The content playback devices, e.g., consumer electronics devices, may be caused to be the source of the request for a content item from a service provider, e.g., by providing the content item URL to the content playback device from the second display for a subsequent request to a service provider.

In the case that the software includes a plug-in within the browser to playback content items in the browser, the browser may provide the media data to the plug-in in a stream. The plug-in can buffer the media stream and direct the content item to the consumer electronics device that it instructed to play the media. The second display application may also prepare and update the browsing history that is presented to the user by the browser.

The second displays provide complementary functionality to the IPTV, but generally do not require additional investment by the user because the same make use of a device, e.g., a smartphone, laptop computer, tablet computer, a desktop, an internet appliance, etc., which most users would already have in their possession. Such a second display is a desirable complement to an IPTV because of the second display's strength in supported languages and character font sets, data entry, processing power, and user experience in content management. The application running on the second display may be a web application (scripting or non-scripting), a native application, a Java application, or any other sort of application that may be employed with a content playback device. For example, the ASP/.NET framework with RPC can be employed to write the second display application. Where the web application running on the second display is written in HTML or HTML with Javascript, the same may be loaded by any device with a browser, and so the same is not limited to only a small set of compatible devices or expensive remote controls.

Communications with service providers may take place through a proxy server, and the proxy server presents to service providers the authentication credentials of the content playback device, so that the second displays appear to the service providers as authenticated content playback devices.

The second displays may include any device that can run an application that communicates with a content playback device, including, but not limited to, personal computers, laptop computers, notebook computers, netbook computers, handheld computers, personal digital assistants, mobile phones, smart phones, tablet computers, hand-held gaming devices, gaming consoles, and also on devices specifically designed for these purposes, in which case the special device would include at least a processor and sufficient resources and networking capability to run the web application.

The content playback device can take many forms, and multiple content playback devices can be coupled to and selected within a given local network. Exemplary content playback devices may include IPTVs, DTVs, digital audio systems, or more traditional video and audio systems that have been appropriately configured for connectivity. In video systems, the content playback device includes a processor controlling a video display to render content thereon.

In a general method, a user employing a second display has a user account with a source or clearinghouse of services. Here, the source or clearinghouse is represented as a user account on a management server, but it should be understood that the user account may be with a service provider directly. In any event, this account has information stored thereon related to what content playback devices are associated with the account. When a user logs on, they may see this list of content playback devices and may choose a particular content playback device. If there is only one content playback device on the network, or if the user is browsing in a way that the content playback device identity is not needed, then this step may be omitted.

Once a content playback device has been chosen, a list of services may be displayed (if more than one is available). The list of services may be customized to those that have content playable on the chosen content playback device, or all available content may be displayed, in which case, in certain implementations, a notation may be displayed adjacent the content item as to whether it is playable on the selected device. Where no content playback device has been selected, all available content may be displayed. If no content playback device has been selected, but the user account includes stored information about which content playback devices are available, then all content may be displayed, a subset of all content may be displayed based on the known content playback devices associated with the account, or notations may be presented about which content playback devices can play which content, or a combination of these. In some cases, a content service provider may require a content playback device to be chosen. In other cases, no content playback device need be chosen and the user may simply choose and queue content for later playback by a content playback device to-be-determined at a later time.

In addition to a list of available services, a list of favorite services and/or assets may be displayed. If a content playback device has been selected, the list may be filtered so that it only displays those services suitable for receipt by the selected content playback device.

Assuming multiple services are available, the user then selects a service to browse. The service presents a list of available content items as noted above. The presentation may be in any number of forms, including by category, or in any other form of organization. The proxy server presents an authentication credential of the content playback device to the content server. In some cases, service provider credentials for accessing the various services may be stored in the account, and presented by the proxy server or management server to the content server when needed.

If the service selected by the user has been chosen from a filtered list of services available to the selected content playback device, only those content items associated with the selected service which are suitable for receipt by the selected content playback device may be displayed. For favorites lists, the same may be filtered at the services level and at the content item level so that the user is only presented with those content items that can be utilized by the selected content playback device. The filtering may occur on the server side or at the second display.

Individual services may employ their own DRM schemes which the current system may then incorporate. For example, if a video content service provider only allows a certain predetermined number of devices on which their content may be played back, then this rule will be enforced or duplicated within the current system and method. Moreover, changes to such service provider parameters may be periodically polled for by the proxy server and/or management server, or the same may be polled for at the next login of the service. In other words, upon login, the system and method may poll for and receive a token associated with the given service provider, the token providing information to the system about the user account with the content service provider.

The system and method may include a management server which, along with the content playback device, communicates with at least one content server such that the content server provides content items for presentation or access of the content item at the content playback device. The system and method may further include a proxy server communicating with the management server and the second displays. In some cases, the proxy server may be merged with the management server, or in other cases a separate proxy server may be provided for each content server or service provider. In another aspect, a proxy server includes at least one processor and at least one network interface communicating with the processor to establish communication between the processor and a wide area network. At least one computer-readable storage medium is accessible to the processor and bears logic causing the processor to receive login information from a second display. Responsive to a determination that the login information is correct, the server sends to the second display a local IP address of the content playback device associated with the login information. The proxy server receives from the second display information about the content playback device requesting a list of services available to the content playback device from at least one content server of a service provider and sends a request for the list of services to a management server. The proxy server receives from the management server the list and sends it to the second display for presentation of information on a video display thereof In addition, the proxy server may send to the second display the list of favorite services and/or assets, which may be filtered so that it only includes those services or assets which are available to the specified content playback device. In some cases the list may be obtained from the management server or the content server. The filtering of the list to tailor it for the specified content playback device may be performed by the management server, the content server, or the proxy server.

After the second display selects a service, the proxy server sends to the second display a list of content items provided by that service. The proxy server may also send to the second display a list of favorite content items associated with the user and provided by that service. In some cases the list may be obtained from the management server or the content server.

The proxy server receives from the second display a request for a content item and, responsive to the request of the content item, requests a service login of the content server. The proxy server receives back from the content server a list of items, assets, categories or services and sends the list to the second display. In this way, the list can be presented on a video display of the second display so that a user can navigate to enter a selection to command the content playback device to play the selection.

In one aspect, the invention is directed towards a method of viewing and manipulating on a second display a list of favorite content items from different services, including: establishing a browsing session between a second display and a server, and associating the browsing session with a user account of a user; accessing a first service provider as a first source of content items; receiving a first content list from the first service provider; selecting a first content item from the first service provider to be added to a list of favorites; accessing a second service provider as a second source of content items; receiving a second content list from the second service provider; selecting a second content item from the second service provider to be added to the list of favorites; storing the list of favorites; and upon request, displaying the list of favorites.

Implementations of the invention may include one or more of the following. The method may further include receiving an identifier of a content playback device on which a content item is to be played back; accessing the list of favorites; and filtering the list to include only those content items available for playback on the content playback device. The filtered list may be presented in a web browser on the second display. The method may further include transmitting the list of favorites to another second display. The transmitting may include making the list of favorites available for subscribing by another second display. The list of favorites displayed by the another second display may be filtered based on the another second display's device configuration. The list of favorites displayed by the another second display may be filtered based on the another second display's subscription status. The selecting a content item to be added to the list of favorites may occur before, during, or after playback of the content item. The method may further include receiving an identifier of a content playback device on which a content item is to be played back, and sending the identifier to the server; accessing the list of favorites; and receiving a filtered list of favorites, the filtered list including only those content items available for playback on the specified content playback device.

In another implementation, the invention is directed towards a non-transitory computer-readable medium, comprising instructions for causing a computing device to implement the above method.

In another aspect, the invention is directed towards a method of providing for viewing and manipulation on a second display a list of favorite content items from different services, including: establishing a browsing session between a second display and a management server, and associating the browsing session with a user account of a user; receiving a request for access of a first service provider as a first source of content items; returning a first content list from the first service provider to the second display; receiving a selection of a first content item from the first service provider to be added to a list of favorites, and causing an identifier of the first content item to be added to the list of favorites; receiving a request for access of a second service provider as a second source of content items; returning a second content list from the second service provider to the second display; receiving a selection of a second content item from the second service provider to be added to a list of favorites, and causing an identifier of the second content item to be added to the list of favorites; and upon request by a second display, causing a display of the list of favorites on the second display.

Implementations of the invention may include one or more of the following. The method may further include receiving an identifier of a content playback device, and filtering the list caused to be displayed to include only those content items available for playback on the content playback device. The list may be configured to be presented in a web browser on the second display. The method may further include establishing a browsing session between another second display and the management server, and associating the browsing session with a user account of another user; receiving a request for access of the list of favorites; and making the list of favorites accessible by the another second display. The making the list of favorites accessible may include transmitting the list of favorites to the another second display. The making the list of favorites accessible may include verifying that the another second display is entitled to receive the list of favorites. The method may further include filtering the list of favorites based on the another second display's device configuration. The method may further include filtering the list of favorites based on the another second display's subscription status.

In another implementation, the invention is directed towards a non-transitory computer-readable medium, comprising instructions for causing a computing device to implement the above method.

Advantages of certain embodiments of the invention may include one or more of the following. Additional ways are provided to control TVs through a secondary display. Use of a second display affords significant additional features over the case of browsing solely on an IPTV, e.g., certain content items are easier to review and select on a second display than on a content playback device. In addition, by maintaining a list of favorites associated with the user's account or with the second display, the user is provided with a convenient method to access items of particular interest on different content playback devices. Where users access content from multiple content servers, which may or may not be operated by different service providers, the user may have a global list of favorites, instead of requiring the user to request and receive a separate list from each of the service providers.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with one aspect of the present principles.

FIG. 2 is a sequence diagram illustrating a system and method according to another aspect of the present principles.

FIG. 3 is a flowchart illustrating an exemplary method according to yet another aspect of the present principles.

FIG. 4 is a flowchart illustrating another exemplary method according to a further aspect of the present principles.

FIG. 5 is a flowchart illustrating another exemplary method according to a further aspect of the present principles.

FIG. 6 is a block diagram of an exemplary second display system in accordance with another aspect of the present principles.

FIG. 7 is a block diagram of an exemplary server system in accordance with another aspect of the present principles.

FIG. 8 illustrates an exemplary computing environment, e.g., that of the disclosed second display, proxy server, management server, or content server.

### DETAILED DESCRIPTION

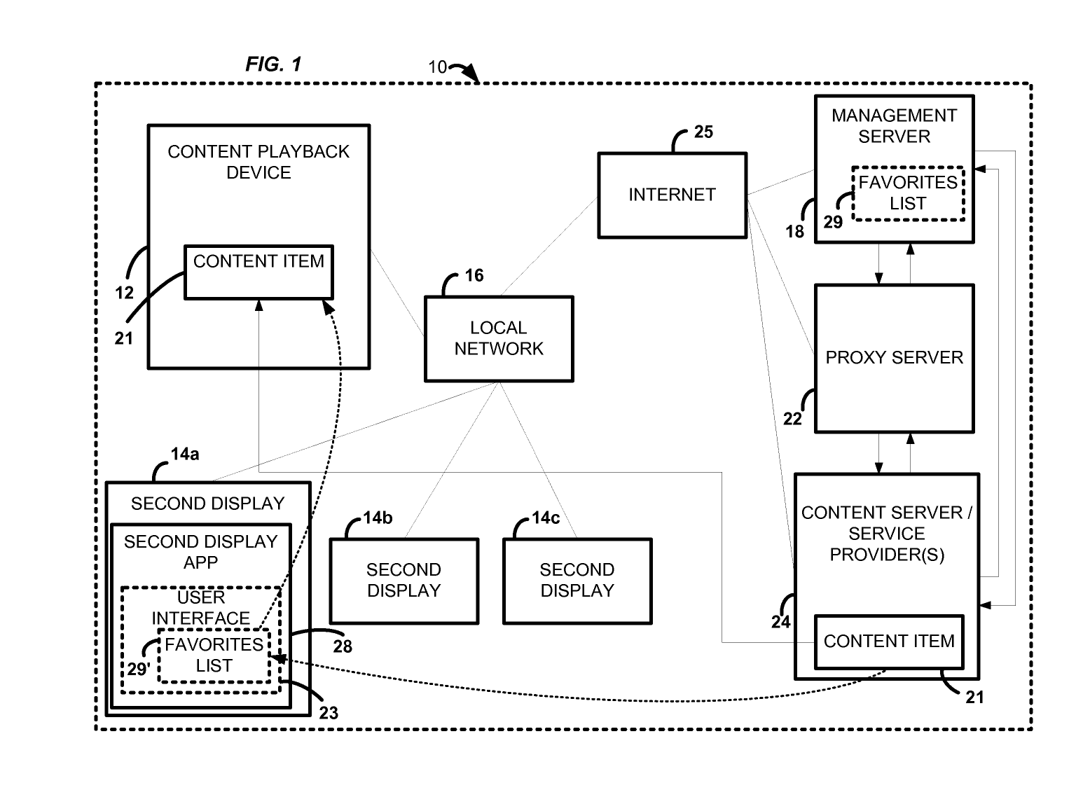

Referring initially to FIG. 1, a system 10 is shown including a content playback device 12 coupled to a local network 16, which may be wired, wireless, or a combination of both. Also coupled to the local network 16 are one or more second displays 14a-14c, an exemplary one of which is termed herein second display 14i. A number of servers may be accessed by the content playback device 12 and the second display 14i through the local network 16 and the internet 25, including a management server 18, a proxy server 22, and one or more content servers 24 corresponding to service providers.

A content item 21 may be stored on a content server 24 and the same may be selected, or in certain cases even in part viewed, by a second display 14a. In particular, the content item 21 may be browsed and selected using a second display application 28, which in some embodiments may be a web application. In some cases, particularly when a conventional web browser is employed, a plug-in or helper application (not shown) may run in the browser to facilitate viewing of the content item. The user of the second display 14a can then direct that the content item be displayed in the content playback device 12. In so doing, the user can, e.g., employ a user interface 23 of the second display application 28 to indicate this direction. A signal is then transmitted from the second display 14a to cause the content item 21 to playback on the content playback device 12.

The content playback device 12 may obtain the content item 21 for playback in a number of ways. Generally, the content playback device 12 receives the content item 21 from the service provider (or an intermediary source). For this type of transmission, the second display 14a may send a signal to the service provider through the local network 16 and/or internet 25 to the service provider. In another case, where the second display application is a web application, the same may include JavaScript in HTML that directly passes the desired URL onto the content playback device. If necessary, the proxy server 22 may be employed, although in some cases content items 21 suitable for viewing in the second display application 28 may be obtained directly from the service provider. Many of these include DRM-free content or other freely-distributable content. In any case, other details about methods by which a second display may request that a content item appear on a content playback device are described below.

In some cases, the second display 14a may directly transmit the content item 21 to the content playback device 12. This direct transmission may be by way of a direct wired or wireless connection, such as via USB, Wi-Fi, or the like. For such direct transmissions, the second display 14a may act to buffer the media stream constituting the content item 21 in some implementations.

The content playback device 12 may be, e.g., an IPTV, a digital TV, a digital sound system, a digital entertainment system, a digital video recorder, a video disc player, a combination of these, or any number of other electronic devices addressable by a user on the local network 16. For the sake of simplicity, in this specification, the content playback device 12 will generally be exemplified by an IPTV, in which case it will typically include a processor that controls a visual display and an audio renderer such as a sound processor and one or more speakers. The processor may access one or more computer-readable storage media such as but not limited to RAM-based storage, e.g., a chip implementing dynamic random access memory (DRAM), flash memory, or disk-based storage. Software code implementing present logic executable by the content playback device 12 may also be stored on one of the memories shown to undertake present principles. The processor can receive user input signals from various input devices including a remote control device, a point-and-click device such as a mouse, a keypad, etc. A TV tuner may be provided in some implementations, particularly when the content playback device 12 is embodied by an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the internet 25, or between the second display 14i and the internet, may also take place through means besides the local network 16. For example, the second display 14i may communicate with the content playback device 12 through a separate mobile network.

The one or more second displays 14a-14c each bear a processor and components necessary to operate an application, e.g., a second display application and possibly a browser plug-in or helper application. Other types of applications may also be employed, so long as the same are capable of transmitting (and optionally playing) the selected media or otherwise specifying the network location of the same to a target device for subsequent playback. In particular, the processor in the second display may access one or more computer-readable storage media such as but not limited to RAM-based storage, e.g., a chip implementing dynamic random access memory (DRAM), flash memory, or disk-based storage. Software code implementing present logic executable by the second display may also be stored on one of the memories shown below to undertake present principles. Further, the second display 14i can receive user input signals from various input devices including a point-and-click device such as a mouse, a keypad, a touchscreen, a remote control, etc. A network interface such as a wired or wireless modem communicates with the processor to provide connectivity to wide area networks such as the Internet as noted above.

The servers 18, 22, and 24 have respective processors accessing respective non-transitory computer-readable storage media which may be, without limitation, disk-based and/or solid state storage. The servers communicate with a wide area network such as the internet via respective network interfaces. The proxy server 22 may in some cases be combined with the management server 18, although in many cases it may be preferable to separate the servers to better accommodate server load. The servers may mutually communicate via the internet 25. In some implementations, the servers may be located on the same local network, in which case they may communicate with each other through the local network without accessing the internet. For example, in one exemplary implementation, the management server 18 and the proxy server 22 may be disposed in the same data center, so communication between the two may stay within the data center.

While exemplary methods of the system are described below, certain method steps especially pertinent to certain arrangements of the second display will be described here.

Responsive to the second display 14i sending a request to the proxy server 22 for an executable utility, the proxy server 22 returns the utility to each second display 14i. Running the utility causes the instantiation of an application. The implementation discussed here includes a web application, but it will be understood that other types of applications may also be employed. The second display 14i, executing the web application, prompts a user to input to each second display 14i login information. The login information may be common or may differ between second displays. The proxy server 22, responsive to reception of correct login information from the content playback device 12, returns the local network (e.g., IP) address of the content playback device 12 to the second display 14i, because the same has previously been registered to a user account in which such information is maintained. The proxy server 22 may also return a list of content playback devices on the local network, responsive to which the second display 14i may select one for content playback. In turn, each second display 14i uses the local content playback device address to access the content playback device 12 directly to request information about the content playback device 12, which information is returned from the content playback device 12 to the second display 14i such that the local address of the content playback device 12 need not be globally addressable. Each second display 14i may also select content for playback on different content playback devices. The second display 14i sends the information about the content playback device 12 to the proxy server 22, requesting a list of services available to the content playback device 12 from one or more service providers. The services may be dependent on the device characteristics of the content playback device 12 chosen. For example, if the chosen content playback device 12 is an IPTV, video services may be returned. If the chosen content playback device 12 is an audio system, audio services may be returned.

The proxy server 22 relays the request for a list of services to the management server 18, which returns the list to the proxy server 22, with the proxy server 22 in turn sending the list to the second display 14i for presentation of information on the second display 14i. Responsive to a user selection of an item on the list, the second display 14i sends a request for a software asset corresponding to the selected content item to the proxy server 22. The proxy server 22 requests a service login of the content server 24 providing the content, and the content server 24 provides to the proxy server 22 a list of content items, assets, categories, or services, and the proxy server 22 relays the list to the second display 14i, which is presented on the second display 14i so that the user can navigate to enter a selection. Responsive to the selection, the second display 14i sends a command to the content playback device 12 to access and play back the selection.

The content server or servers 24 may maintain a list of favorite content items associated with the user's account or with the second display 14i. These lists provide a convenient method by which the user can quickly and easily access items of particular interest on different second displays or content playback devices. The content server 24 may provide this list to the user when the user requests the same from the content server 24. The list of favorites may be provided to the user on the second display 14i whenever the user accesses the content server 24 or only when specifically requested by the user. In some implementations the list of favorites and/or recently viewed items may be maintained by the proxy server 22 instead of the content server 24, and generally, in this case, a list may include content items from multiple services.

In particular, in those cases where users access content from multiple content servers, which may or may not be operated by different service providers, it may not be practical or desirable for the user to request and receive a separate list from each of the content servers. In these cases each content server may send its list to the management server or proxy server. The management or proxy server can then combine the individual lists to create and maintain a global list that can be made available to the second display.

In any case, when the user accesses a service or selects a content item or other asset, a record is created in which the asset identifier (ID) is associated with the user and stored on the appropriate server. The record may also associate the asset ID and user ID with the second display or content playback device from which the user request was received.

When a user receives a favorites list, that list may include all such assets associated with the user which have been selected as favorites, regardless of which device previously received the assets on the list. For instance, some of the assets may have been presented on content playback device 12 while other of the assets on the list may have been presented on another content playback device or on one of the second displays 14a-14c. However, not all assets may be suitable for receipt by or presentation on all the available devices. This may be particularly important where a selected device has a completely different set of capabilities as a previously selected device. For instance, assets that may be suitable for presentation on an IPTV may not be suitable for presentation on a DTV, a digital audio system, or a Blu-ray® player.

As one particular example, a first selected device may be an IPTV, and a second selected device may be an audio receiver. Some level of filtering may be desirable because the audio receiver cannot playback video content, and the ability to choose video content while the audio receiver is selected may lead to consumer confusion. Of course, in certain implementations, in the above scenario, a user may be given the option to playback merely the audio portion of a multimedia content item on an audio system. In another example, a first selected device may be an IPTV, and a second selected device may be a smart phone. In this case, multimedia content may be presented on the smart phone, but at a significantly different resolution than on a typical IPTV. In the same way, certain services or content items may not be available in certain regions for contractual or government reasons. Such services or content items may then be disabled or filtered out from displaying on a second display when the second display has selected a device in that region for playback. By filtering out these unavailable services and/or content items, consumer confusion can be greatly reduced because the consumer is no longer offered a choice of a service or content item that is unavailable.

Once the user designates to the proxy server 22 a particular content playback device 12 that is to receive an asset, the proxy server 22 may filter the favorites before providing the list to the user on the second display 14i. The filtering may be performed so that only those favorite assets suitable for receipt by the designated content playback device 12 will be included in the list(s). The proxy server 22 can perform this filtering process using the information about the designated device which was previously received from either the second display 14a or the designated content playback 12 device itself Accordingly, when the user receives the favorites list from the proxy server 22, either automatically or upon user request, the list may only show those assets that are available for the selected content playback device. In this way, the favorites list of content items, assets, categories, or services may be synchronized across all content playback devices registered to that user. It is noted that while the proxy server 22 has been described as performing this function, in many cases the management server 18 may also perform it.

In those implementations in which the favorites list is provided to the user by the content server 24, the filtering process may be performed by the content server 24 (after receiving the necessary information from the proxy server 22) or the proxy server 22 (or management server) may perform the filtering process itself after receiving the list from the content server 24.

In another implementation, the filtering can also be performed by the second display application. In this case, the list that is played by the second display may be a global list of all favorite assets from various services. The filtering is performed based on the IPTV device that is currently selected by the second display application.

The command from the second display 14i to play the content item may be in a number of forms. The second display 14i may communicate to the proxy server 22 the request on behalf of the content playback device 12, and this request may be via the local network or via other means. Alternatively, the second display 14i may transmit a request to the content playback device 12 that it itself formulate the request, and this transmission may be by way of the local network, the internet generally, or via other means such as other wired or wireless transmission schemes, including via USB, IR, Bluetooth®, or any other schemes. If the second display 14i is configured to address the content playback device 12 at a local level, e.g., at the server level, then the second display 14i may be physically located virtually anywhere and still be able to queue content or to command the content playback device 12 to play content. In this case, however, server load would increase over the case where the second display and content playback device communicated directly or over a local network.

Certain method steps of an arrangement of the content playback device are described here. Using a network interface, the content playback device 12 can communicate with a management server 18 on the Internet and with the one or more content servers 24, also on the Internet and communicating with the management server 18. The management server 18 receives and stores a local IP address of the content playback device 12. The content playback device 12 communicates with the management server 18 to arrange for content items from the content server 24, operated by a service provider, to be played back on the content playback device 12. In more detail, the content playback device 12 sends login information to the management server 18 which returns to the content playback device 12 a user token that must subsequently be presented by the content playback device 12 to the content server 24 to obtain content from the content server 24.

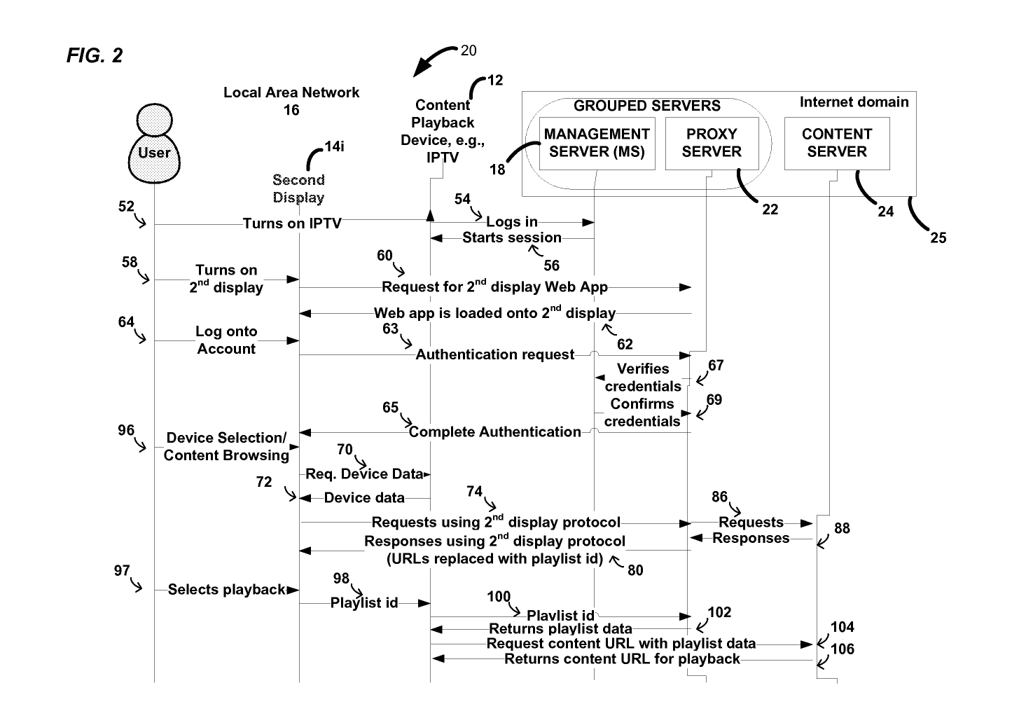

FIG. 2 is a sequence diagram illustrating an exemplary implementation of the system and method for enabling a user to employ a second display to browse content playback devices, service providers, and content items and select the same for playback by a content playback device. FIG. 2 assumes that the user has already created an account with a management server and has affiliated one or more content playback devices with that account.

At state 52, a user turns on the content playback device 12. At state 54 the content playback device sends login information including, e.g., username and password, to the management server 18, which at state 56 returns to the content playback device a user token that may subsequently be presented by the content playback device to a content server 24 to obtain content from that server. The management server 18 in addition stores the local IP address of the content playback device 12.

At state 58, the user turns on the second display 14i and, e.g., instantiates a session such as a web browser session in which control may be exercised over the content playback device. A utility is executed on the second display 14i, at state 60, which sends a request to the proxy server 22, which returns in state 62 an application, e.g., HTML with JavaScript, for the second display to execute for browsing content items. This application may make, e.g., asynchronous JavaScript and XML calls to the proxy server 22 and to the content playback device 12 to obtain information to control the content playback device 12.

With more specificity, at state 64, using the JavaScript received from the proxy server 22, the second display 14i prompts the user to input to the second display 14i the account login information, including, e.g., the same username and password that the content playback device provided to the management server 18 in state 54 during device registration. Of course, the account login information may differ as well. It will be appreciated that the servers 18, 22, and 24 communicate necessary account information between them as needed to realize the principles described here.

The proxy server 22 responds to a correct user name and password from the second display 14i in an authentication request state 63. The proxy server 22 verifies the user name and password with the management server 18 (states 67 and 69), creates and transmits a session token to the second display, obtains information about content playback devices affiliated with the user account, and completes the authentication in state 65. The proxy server 22 may return to each second display the information about all content playback devices 12 that are affiliated with the user account associated with the user name and password, including their local IP addresses which were stored by the management server 18 after login at 54 (and subsequently provided to the proxy server 22). In more detail, the proxy server 22 sends a token to the second display 14i, the token associated with a content playback device, and this token gets communicated in future transactions between the second display and the proxy server, so that the proxy server 22 knows what content playback device the content item is intended for. Each user with each second display may then choose a content playback device and browse the services and content options available through the services in state 96 and subsequent steps.

The second display 14i, using the local IP address returned as noted above, accesses the content playback device directly, in the sense of communicating through the local network. To select a particular content playback device, the second display 14i requests information about the content playback device 12 at state 70, including language information, digital rights management (DRM) information, etc., as desired, which information is returned from the content playback device to the second display 14i at state 72. Since the second display 14i knows the IP address of the content playback device 12 and consequently communicates directly with the content playback device 12, the second display 14i communicates using a local web address of the content playback device 12 that need not be globally addressable, and may so communicate as long as the second display 14i and content playback device 12 are on the same local network.

Each second display 14i may send the client information received at state 72 to the proxy server 22, requesting a list of services available to the content playback device 12, or that the content playback device 12 is entitled to, from one or more of the content servers 24. The proxy server 22 relays the request to the management server 18, which returns the requested service list to the proxy server 22. The proxy server 22 in turn sends the services list to the second display for presentation of available services on, e.g., the second display. In addition to the services, a favorites list may be provided to the second display. As previously discussed, this list may be filtered so that it only includes those services that are available to the content playback device 12 that was selected in state 96. Each user browses the services and their content on the second display just as though it were the actual content playback device.

A user can input, using, e.g., a second display input device, a selection of a service on the list that was returned to the second display. In response, the second display, at state 74, sends a request for the corresponding service to the proxy server 22 along with the service token that that second display may have received from the content server 24 via the management server 18.

Responsive to the request, the proxy server 22 requests a service login at state 86 of the content server 24 providing the selected service. At state 88, the content server 24 provides to the proxy server 22 a list of content items, assets, categories or services, as the case may be, for the particular content server 24. If desired, the proxy server 22 may also request of the content server 24 a list of options, and the list may be returned in, e.g., extended markup language (XML) format to the proxy server 22 which relays the content items, assets, categories, services, etc. available for selection to the second display at the state 80. If the filtered favorites list is provided by the content server 24 to the proxy server 22, this request from the proxy server 22 to the content server 24 may also include a request for such a filtered list.

The content available for selection is presented on the second display so that the user can navigate in state 97 the display to enter a selection. Responsive to the selection, the second display at state 98 sends a command to the content playback device 12 to play the selection, and in particular sends a playlist identifier or reference identifier indicating the selection. At state 100, the content playback device 12, using its authentication credentials, sends the playlist identifier or reference identifier to the proxy server 22, which returns the required playlist data in state 102. The content playback device 12 can then request the content URL with the playlist data in state 104, which may be responded to with a return of the content URL for playback of the content item on the content playback device 12 in state 106.

Variations of the system and method are now described.

If the content playback device were already playing content, the new content commanded to be played by the second display may interrupt the current content. Alternatively, the new content may be placed in a queue in the content playback device and played when the current content completes. In any case, once the content has been commanded to be played, the user may continue to browse the second display for other content, to play or to add to the queue. Other users may employ their own second displays to do the same. A user may also desire to switch devices and resume playback on a different device by, e.g., navigating to a “recently viewed” list and selecting the last video played after switching control to the desired device. In the same way as noted above, the recently viewed list may be filtered to only include those recently viewed items available to the content playback device which has now been given control.

The above description has been for the case where the proxy server 22 is employed to hide the content source, e.g., a content URL, from the second display 14i. That is, the proxy server 22 provides an API for the second display to use so that the content and/or content URL cannot be accessed directly, i.e., the details of the management server transactions to access the services remain desirably unknown. In many cases, the second display 14i may have stored thereon little or nothing of the content playback device 12 details. In some cases, however, the URL may be directly provided from the proxy server 22 or the proxy server 22 may even be bypassed, e.g., in cases where the content item is intended for free distribution, e.g., movie trailers or the like. If the URLs are made available to the second display 14i, the list of favorites or other assets available to the user may be presented to the user through the second display application. If the second display application is, or includes, a web browser, the list may be presented in the native bookmarking feature often available in such web browsers.

Similarly, while the above description has focused on content item playback on content playback device 12, certain content items, e.g., those which are intended for free distribution, may be played back on the second display 14i itself, if the same has been appropriately configured, e.g., via using the second display application and/or the plug-in or helper application described.

In the case where multiple second displays request content to be played at or near the same time, a simple rule such as the first-in-time may prevail. Alternatively, a priority scheme may be configured, such that certain second displays take precedence over other second displays.

Note further that the control device may command the content playback device to play content by sending to the content playback device over the local network commands coded as if they were sent from an infrared remote control, specifically for example the commands may be in the Sony Infrared Remote Control System (SIRCS) protocol.

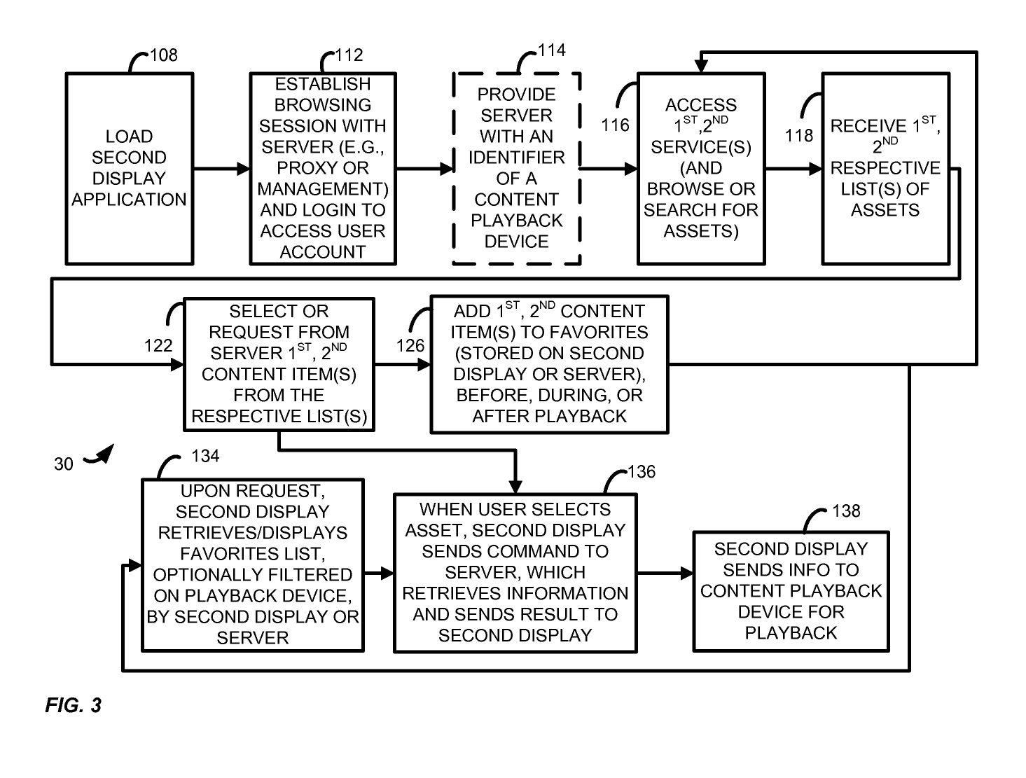

FIG. 3 is a flowchart 30 exemplifying one way to implement a method to add an asset as a favorite for convenient future access or for sharing, particularly from the point of view of a second display. A first step is to load a second display application on a second display (step 108), and to establish a browsing session with a server, the browsing session generally associated with a user account (step 112). The server may be a management server or a proxy server as discussed above. A next step, which is optional, is to provide the server with an identifier of a content playback device (step 114). By doing so, results returned may be filtered based on the type of content playback device or the digital rights allowed to the content playback device.

A next step is to access a first service and browse or search for assets thereon (step 116). A first list of assets is then received by the second display (step 118). For example, if the user accesses a video service, the first list of assets may be a set of “top hits”. By navigating to a children's category, a list of assets may be returned of children's videos. A user may then select or request from the server a first content item from the list (step 122). Based on the desire of the user, the same may at the first content item to a list of favorites before, during, or after playback of the content item (step 126). Of course, in some implementations, no such playback need occur; the user may simply add the content item to the list of favorites. In addition to adding the content item or asset to a list of favorites employing a routine at the second display or server, the content item or asset may be added to the list of favorites from the service provider website, if the service provider implements an appropriate second display plug-in application. In any case, the list of favorites may be stored on the second display or on the server.

Besides adding the content item to the list of favorites, the user may select the asset for playback. In this case, when a user selects an asset from the list, the second display sends a command to the server, which retrieves information about the selected asset and sends the result to the second display (step 136). The second display may then send information needed for playback to the content playback device, e.g., an IPTV (step 138) as discussed above in connection with FIGS. 1 and 2.

As shown in FIG. 3, the method may repeat for a second service, second list of assets, and second content item so as to build up the list of favorites.

Upon request, the second display may retrieve and display the list of favorites (step 134). The same may be caused to automatically display upon loading of the second display application, or may be an option activatable by the user. The list may be filtered on the content playback device as discussed, and the filtering may be performed by the second display or by the server. Once the list of favorites has been displayed, the user may select an asset for playback in steps 136 and 138 as described above.

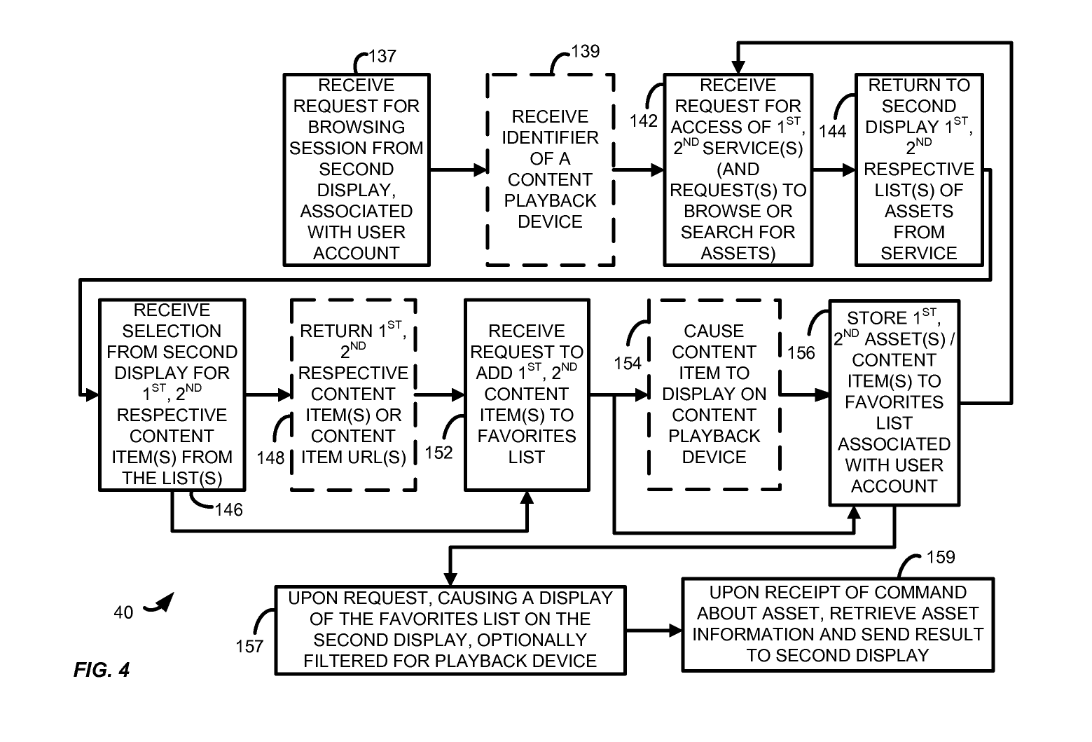

FIG. 4 is a flowchart 40 exemplifying one way to implement a method to add an asset as a favorite for convenient future access or for sharing, particularly from the point of view of a server. A first step is to receive a request for a browsing session from a second display, generally associated with the user account (step 137). In some instances, no user account is required, but a user may be prompted to create one, or to create an affiliation with a service. A next step, which is optional, is to receive an identifier of a content playback device (step 139). As in the method above, this step if employed allows a degree of filtering to be provided on returned results, ensuring that content lists and assets are appropriate for the intended device. A next step is to receive a request for access of a first service, as well as subsequent request to browse or search for assets within the service (step 142). In this step, the server receives a request from the second display to access the service, and provides any direction to the service to enable searching, browsing, or the like. A next step is to return to the second display a first list of assets from the service (step 144). As above, this may correspond to a category listing or other way in which content items or assets may be organized by lists. A next step is to receive a selection from the second display for a first content item from the respective list (step 146). Optionally, the first content item may be returned to the second display, either per se or in the form of a URL corresponding to the content item (step 148). Based on the desires of the user, a request may be received to add the first content item to a favorites list (step 152). The content item may then be caused to display on the content playback device (step 154), generally by having the content playback device request the content item using information provided by the second display. A notation of the first content item may then be stored to a favorites list associated with the user account (step 156).

As may be seen, this cycle of requesting services, content lists, and content items, as well as requesting that content items be saved in to a favorites list, may then be repeated. In the flowchart 40 of FIG. 4, this is indicated by first and second services, and respective content lists and items.

Upon request, the server may then cause the display of the favorites list on the second display (step 157). Optionally, the list caused to be displayed may be filtered for the playback device. The display may be caused by a specific request from the user via the second display application, or may be automatically provided by the server in some implementations. For example, a user may set preferences such that their favorite assets are automatically displayed upon loading or instantiation of the second display application.

Upon receipt of a command about the content item, content item information may be retrieved and the results sent to the second display (step 159). The content item may then be caused to play on the content playback device.

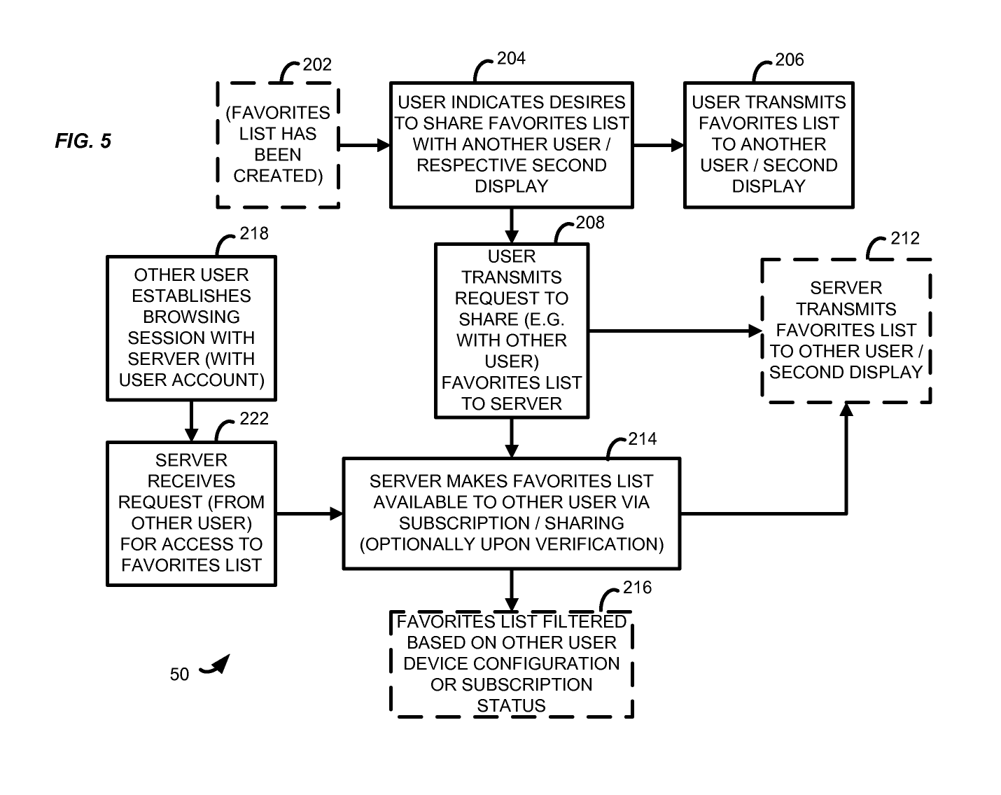

FIG. 5 illustrates a flowchart 50 by which a favorites list may be shared with other users. The flow chart 50 assumes that a favorites list has been created (step 202), e.g., using the methods described above. In a first step, a user indicates their desire to share their favorites list with other users (step 204). In one implementation, a user may transmit their favorites list to another user and second display (step 206), by a transmission over a network or directly via infrared, WiFi, Bluetooth®, or the like. In another implementation, a user transmits a request to share their favorites list, e.g., with another user, to a server (step 208). The server then makes the favorites list available to other users (step 214).

To make the favorites list available to other users, various techniques may be employed, including having other users subscribe to the favorites list, or via other ways in which the favorites list may be shared with other users. An optional step may be to verify the other user, to ensure that the list is not shared outside of a desired set of users. When the other user receives the favorites list, or receives access to the same, the list may be filtered based on various factors (step 216). For example, the list received may be filtered based on a device configuration of the other user. In this way, a user may only see assets they are capable of playing. In another way, the list may be filtered based on a subscription status. In this way, a user may only see assets for which they enjoy adequate playback rights. Alternatively, assets may be shown, but with a prompt to allow the user to obtain such rights prior to allowing playback.

In another implementation, in which a request is instigated by the other user, the other user may establish a browsing session with a server, generally associated with a user account (step 218). The server may be the same as that used by the original user, or may be a server in network communication with the subject user's server. The server accessed in step 218 may then receive a request from the other user for access to the subject user's favorites list (step 222). If the requesting user has already established adequate rights or permissions with the subject user, the list may be made immediately available. If not, consent may be requested of the subject user.

The flow may then pass to step 214: the server makes the favorites list available to the other user in one of the ways discussed, or an equivalent way.

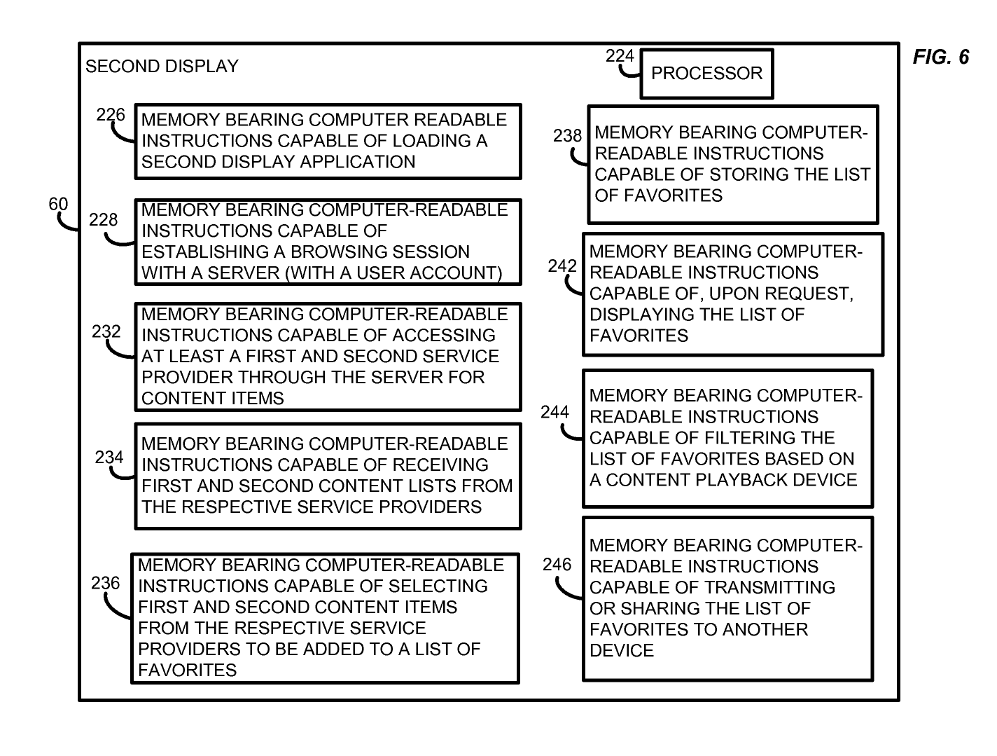

FIG. 6 illustrates one implementation of a second display 60. The second display 60 may include a processor 224 and memory 226 bearing computer-readable instructions capable of loading a second display application. Using memory 226, the second display may load the second display application and prepare the same for use in browsing services, content list, and content items. The second display 60 further includes memory 228 bearing computer-readable instructions capable of establishing a browsing session with a server. As noted above, the browsing session may typically be associated with the user account, or the user may be prompted to create one upon the establishment of the session. The second display 60 may further include memory 232 bearing computer-readable instructions capable of accessing at least a first and second service provider through the server for content items. The second display 60 may further include memory 234 bearing computer-readable instructions capable of receiving first and second content lists from the respective service providers. The nature of the content lists may be as described above.

The second display 60 may further include memory 236 bearing computer-readable instructions capable of selecting first and second content items from the respective content lists to be added to a list of favorites. In this way, the second display may allow the selection of content items for playback or for adding to a favorites list. Of course, it will be understood that in some cases the content item may be chosen as a favorite without the same being part of a content list. The second display 60 further includes memory 238 bearing computer-readable instructions capable of storing the list of favorites. The memory 238 is optional, as the favorites list may also be stored on a server. The second display 60 further includes memory 242 bearing computer-readable instructions capable of, upon request, displaying the list of favorites. The request may come from the server, from the second display, or from any other source. Typically, the list is displayed according to preferences chosen by the user in an options menu. The second display 60 further includes memory 244 bearing computer-readable instructions capable of filtering the list of favorites based on a playback device. That is, if a content playback device has been selected, the list may be filtered based on the capability of the selected content playback device to playback content items in the list. In this way, the user is saved the confusion of having content items appear for which playback is impossible. The second display 60 further includes memory 246 bearing computer-readable instructions capable of transmitting or sharing the list of favorites with another device. The memory 246 may allow the second display to directly transmit the list of favorites, or may alternatively allow the second display to indicate to the server the desire to so share.

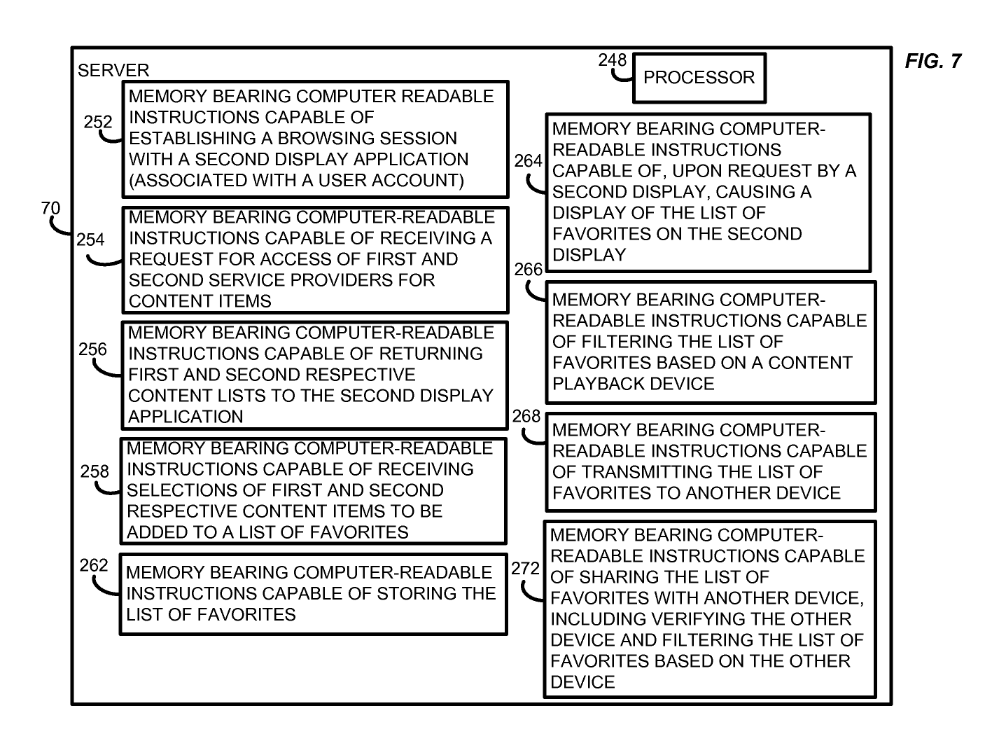

FIG. 7 illustrates an implementation of a server 70 which may be employed to perform one or more of the methods described above. The server 70 may represent a management server, the proxy server, or other servers as may be needed to practice the systems according to the principles disclosed here. The server 70 includes a processor 248 and a memory 252 bearing computer-readable instructions capable of establishing a browsing session with a second display application. The browsing session is generally associated with a user account, or the server may prompt the user to create one. The server 70 further includes memory 254 bearing computer-readable instructions capable of receiving a request for access of first and second service providers as sources of content items. The server 70 further includes memory 256 bearing computer-readable instructions capable of returning first and second respective content lists to the second display application. In this way, e.g., once a first service provider has been accessed, the memory 256 allows the returning of a first content list to the second display, e.g., the second display application. The server 70 further includes memory 258 bearing computer-readable instructions capable of receiving selections of first and second respective content items to be added to a list of favorites. In this way, once a user reviews a content list using memory 256, memory 258 may be employed to add a particular content item from the list to a list of favorites.

The server 70 further includes memory 262 bearing computer-readable instructions capable of storing the list of favorites. The memory 262 generally serves to store the favorites and associate the same with the user account. It is noted, however, that a user account is not necessary, although prior to the closing of the browsing session, a user may be prompted to create one in order to maintain the list of favorites. The server 70 further includes memory 264 bearing computer-readable instructions capable of, on request by a second display, causing a display of the list of favorites on the second display. The nature of the request has been disclosed above, and generally includes causing a display of the list according to settings in an option menu for by manual user operation. Alternatively, a default menu item may be provided corresponding to the favorites list. The server 70 further includes memory 266 bearing computer-readable instructions capable of filtering the list of favorites based on a content playback device. In this case, notification of the selected content playback device is provided to the server 70, so that the same may filter the list caused to be displayed based on such device. The server 70 further includes memory 268 bearing computer-readable instructions capable of transmitting the list of favorites to another device. The memory 268 generally provides for a direct transmission to the desired other device. Alternatively, the server 70 may include memory 272 bearing computer-readable instructions capable of sharing the list of favorites with another device, which may include verifying the other device and filtering the list of favorites based on content playback devices associated with the other device. The memory 272 generally makes the list of favorites of one user accessible to other users, upon verification or the like.

Systems and methods have been disclosed that allow improvement of the user experience of the IPTV without adding to the hardware costs of the unit. The systems and methods allow for adding assets or content items to a favorites list for convenient access or sharing, as well as for sharing of such favorites lists between devices.

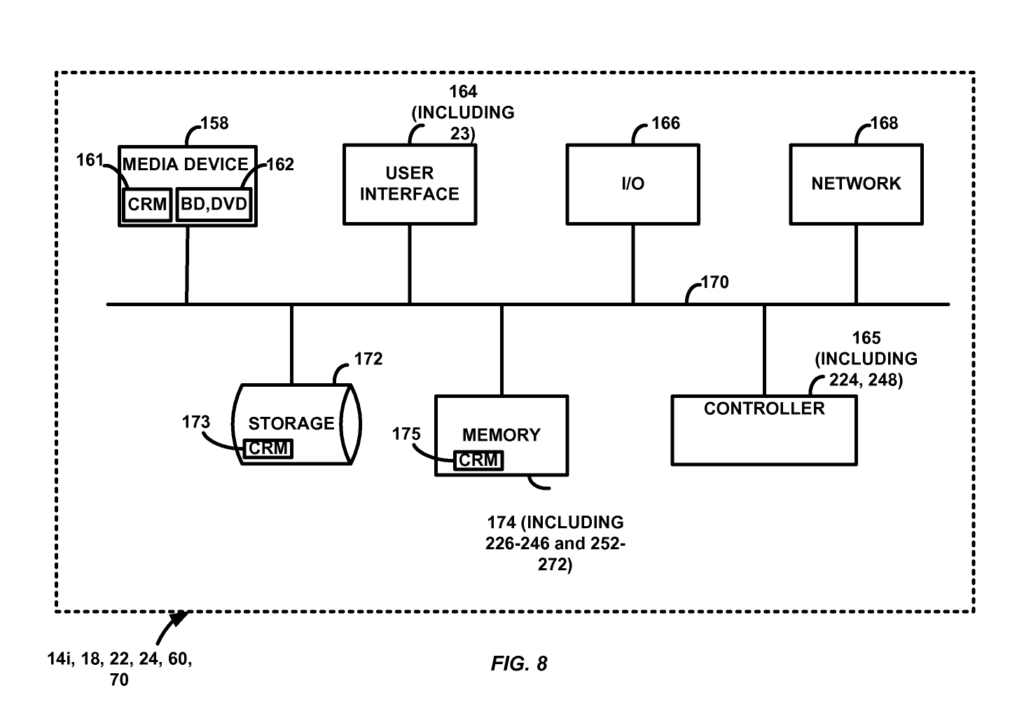

One implementation includes one or more programmable processors and corresponding computing system components to store and execute computer instructions, such as to execute the code that provides the second display or various server functionality, as well as for browsing. The second display 14i functionality will be focused on here, but it will be understood that the various server functionality, e.g., that of the proxy server 22, management server 18, and content server 24, may also be accomplished with such components. Referring to FIG. 8, a representation of an exemplary computing environment for a second display or server is illustrated.

The second display or server includes a controller 165, a memory 174, storage 172, a media device 158, a user interface 164, an input/output (I/O) interface 166, and a network interface 168. The components are interconnected by a common bus 170. Alternatively, different connection configurations can be used, such as a star pattern with the controller at the center.

The controller 165 includes a programmable processor and controls the operation of the second display 14i and its components. The controller 165 loads instructions from the memory 174 or an embedded controller memory (not shown) and executes these instructions to control the system. For example, in its execution, the controller 165 may provide the second display 14i control of a content playback device system 12 as, in part, a software system. Alternatively, this service can be implemented as separate modular components in the controller 165 or the second display 14i.

Memory 174, which may include non-transitory computer-readable memory 175, stores data temporarily for use by the other components of the second display 14i, and the same may include memories 226-246 and 252-272 as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the second display 14i, such as for storing data used by the system. In one implementation, storage 172 is a hard disc drive or a solid state drive.

The media device 158, which may include non-transitory computer-readable memory 161, receives removable media and reads and/or writes data to the inserted media. In one implementation, the media device 158 is an optical disc drive or disc burner, e.g., a writable Blu-ray® disc drive 162.

The user interface 164 includes components for accepting user input, e.g., the user content selections, from the user of the second display 14i and presenting information to the user. In one implementation, the user interface 164 includes a keyboard, a mouse, audio speakers, and a display. The controller 165 uses input from the user to adjust the operation of the second display 14i.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “Wi-Fi” interface (802.11). Numerous other types of network connections will be understood to be possible, including WiMax, 3G or 4G, 802.15 protocols, 802.16 protocols, satellite, Bluetooth®, or the like.

The second display 14i may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention. For example, while in some implementations the second display application running on the second display has been disclosed as a web application, and potentially including a plug-in or helper application, the same may be a native application, a Java application, or any other sort of application that may work with a content playback device. While a favorites list has been discussed in the singular, a user may maintain a number of such lists for various purposes.

Moreover, while several implementations of the invention include that the user select a particular content playback device for playback, in some implementations a user may browse content with no content playback device selected at all. In other implementations, a cache or cookie or other information may be employed to store information about content playback devices, so that no user choice is necessary. In another example, samples of content items may be obtained from content service providers, and these samples may be browsed freely without a user selection of a content playback device for playback. In another variation, a profile system may be employed that communicates content playback device information upon start-up according to a profile; e.g., a given content playback device may always be associated with and may authenticate itself with a given service provider. In this sense, a content playback device is still being chosen, but the choice does not require an affirmative step by the user. Use of any of these alternatives, or others, ensures that the content consumption of each content playback device is tracked. It further allows, as described, the proxy server to filter out content that the content playback device is incapable of playing. It is also noted that certain types of browsing may require no device at all, e.g., browsing shopping sites. Still, some level of customization may occur, e.g., by consideration of the origination location of the visiting second display's IP address.

Content items from any suitable source are contemplated, including but not limited to: networked, wireless, including 3G, 4G, and the like, local, e.g., from a local or shared drive or accessible via DLNA or accessible via a specialized network storage device, or accessible via removable media such as a media card or USB storage device, CD, DVD, or Blu-ray®. Content may also be accessed from a cell phone, portable media player, camera or camcorder, or other devices the second display may access. In addition, any suitable types of content items are contemplated, including but not limited to AC3, MP3, MPEG, etc. Any suitable format of content items is contemplated, including but not limited to m3u, ASX, ASX-XML, etc. Any suitable protection scheme is contemplated, including but not limited to DRM, etc. Any suitable protocol is contemplated, including but not limited to HTTP, HTTPS, etc. Any suitable playback method is contemplated, including but not limited to those varying in buffering limit, when to buffer, treating video playback differently from audio playback, and the like.

In addition, the above description was primarily directed to an implementation in which the local IP address of the second display was retrieved and stored on the server. However, other ways of discovering the second display are also possible. For example, device discovery is also possible using a broadcast method within the local network. Compatible devices that recognize the broadcast message will respond with their necessary credentials and information to indicate their compliance with the web application for the second display. In many cases, broadcasting methods are primarily directed to native applications, not web applications; however, a broadcasting library may be employed to allow the implementation within a web application. It is additionally noted that broadcasting methods may be employed in the discovery of content playback devices by second displays, such as via Bluetooth®, infrared, or the like.

While the above description has focused on implementations where a second display is coupled to a content playback device through a local network, it will be understood that the same will apply to any method by which the two may communicate, including 3G, 4G, and other such schemes.

Accordingly, the present invention is not limited to only those implementations described above.

1. A method of viewing and manipulating on a second display a list of favorite content items from different services, comprising:
i. establishing a browsing session between a second display and a server, and associating the browsing session with a user account of a user;
ii. accessing a first service provider as a first source of content items;
iii. receiving a first content list from the first service provider;
iv. selecting a first content item from the first service provider to be added to a list of favorites;
v. accessing a second service provider as a second source of content items;
vi. receiving a second content list from the second service provider;
vii. selecting a second content item from the second service provider to be added to the list of favorites;
viii. storing the list of favorites; and
ix. upon request, displaying the list of favorites.

2. The method of claim 1, further comprising:
i. receiving an identifier of a content playback device on which a content item is to be played back;
ii. accessing the list of favorites; and
iii. filtering the list to include only those content items available for playback on the content playback device.

3. The method of claim 1, wherein the filtered list is presented in a web browser on the second display.

4. The method of claim 1, further comprising transmitting the list of favorites to another second display.

5. The method of claim 4, wherein the transmitting includes making the list of favorites available for subscribing by another second display.

6. The method of claim 4, wherein the list of favorites displayed by the another second display is filtered based on the another second display's device configuration.

7. The method of claim 4, wherein the list of favorites displayed by the another second display is filtered based on the another second display's subscription status.

8. The method of claim 1, wherein the selecting a content item to be added to the list of favorites occurs before, during, or after playback of the content item.

9. The method of claim 1, further comprising:
i. receiving an identifier of a content playback device on which a content item is to be played back, and sending the identifier to the server;
ii. accessing the list of favorites; and
iii. receiving a filtered list of favorites, the filtered list including only those content items available for playback on the specified content playback device.

10. A non-transitory computer-readable medium, comprising instructions for causing a computing device to implement the method of claim 1.

11. A method of providing for viewing and manipulation on a second display a list of favorite content items from different services, comprising:
i. establishing a browsing session between a second display and a management server, and associating the browsing session with a user account of a user;
ii. receiving a request for access of a first service provider as a first source of content items;
iii. returning a first content list from the first service provider to the second display;
iv. receiving a selection of a first content item from the first service provider to be added to a list of favorites, and causing an identifier of the first content item to be added to the list of favorites;
v. receiving a request for access of a second service provider as a second source of content items;
vi. returning a second content list from the second service provider to the second display;
vii. receiving a selection of a second content item from the second service provider to be added to a list of favorites, and causing an identifier of the second content item to be added to the list of favorites; and
viii. upon request by a second display, causing a display of the list of favorites on the second display.

12. The method of claim 11, further comprising receiving an identifier of a content playback device, and filtering the list caused to be displayed to include only those content items available for playback on the content playback device.

13. The method of claim 11, wherein the list is configured to be presented in a web browser on the second display.

14. The method of claim 11, further comprising:
i. establishing a browsing session between another second display and the management server, and associating the browsing session with a user account of another user;
ii. receiving a request for access of the list of favorites; and
iii. making the list of favorites accessible by the another second display.

15. The method of claim 14, wherein the making the list of favorites accessible includes transmitting the list of favorites to the another second display.

16. The method of claim 14, wherein the making the list of favorites accessible includes verifying that the another second display is entitled to receive the list of favorites.

17. The method of claim 14, further comprising filtering the list of favorites based on the another second display's device configuration.

18. The method of claim 14, further comprising filtering the list of favorites based on the another second display's subscription status.

19. A non-transitory computer-readable medium, comprising instructions for causing a computing device to implement the method of claim 11.
